(19) United States
(12) Patent Application Publication
(10) Pub. No.: US 2019/0340633 A1
(43) Pub. Date: Nov. 7, 2019

(54) SYSTEMS AND METHODS FOR CALCULATING AND PRESENTING INFORMATION RELATED TO THE EFFECTIVENESS OF A PROMOTION

(71) Applicant: Walmart Apollo, LLC, Bentonville, AR (US)

(72) Inventors: Syed Mahmood Mudassir, Shenzhen (CN); Rakesh Sukumar, Bangalore (IN); Mani Kanteswara Rao Garlapati, Bangalore (IN); Sunit Pahwa, Bangalore (IN)

(21) Appl. No.: 16/397,422

(22) Filed: Apr. 29, 2019

Related U.S. Application Data
(60) Provisional application No. 62/694,766, filed on Jul. 6, 2018.

(30) Foreign Application Priority Data
May 1, 2018 (IN) 201841016364

(51) Int. Cl. G06Q 30/02

(52) U.S. Cl. CPC G06Q 30/0211; G06Q 30/0238; G06Q 30/0201

(57) ABSTRACT

In some embodiments, systems, apparatuses, and methods are provided herein useful to calculating and presenting information related to effectiveness of a promotion. In some embodiments, a system comprises a POS system configured to collect sales data for products, a display device configured to present the information related to the effectiveness of the promotion, and a control circuit configured to receive the sales data for products, determine actual sales for a product, calculate baseline sales for the product, calculate halo sales of the affined product, calculate cannibalized sales, calculate one or more of return sales and lost sales, calculate, based on one or more of the actual sales for the product, the baseline sales for the product, the halo sales, the cannibalized sales, the return sales, and the lost sales, a net lift, and present, via the display device, and indication of the net lift.

### CROSS-REFERENCE TO RELATED APPLICATION

This application claims the benefit of Indian Provisional Application No. 201841016364, filed May 1, 2018, and U.S. Provisional Application No. 62/694,766, filed Jul. 6, 2018, which are both incorporated by reference in their entirety herein.

### TECHNICAL FIELD

This invention relates generally to monitoring sales in a retail facility and, more specifically, monitoring sales associated with promotions in a retail facility.

### BACKGROUND

Oftentimes, retailers will run promotions (e.g., sales, discounts, markdowns, etc.) for products. These promotions are used in to increase product sales, trigger sales of old stock, reduce inventory levels, etc. While promotions can be effective for retailers, it is often difficult to quantify the effectiveness of the promotion. For example, if the goal is to increase the sale of a product by running a promotion for the product, considering only gross sales of the product does not give an accurate picture of the total impact that promotion had on sales. For example, while gross sales of the product may increase during the promotion, simply looking at the gross sales for the product may not account for other areas in which sales are lost. Consequently, a need exists for better systems, methods, and apparatuses to calculate and present the effectiveness of a promotion.

### BRIEF DESCRIPTION OF THE DRAWINGS

Disclosed herein are embodiments of systems, apparatuses, and methods pertaining to calculating and presenting information related to effectiveness of a promotion. This description includes drawings, wherein:

FIG. 1 depicts a chart 100 including different components related to sales of a product for which there is a promotion, according to some embodiments;

FIG. 2 is an example user interface presented via a browser 200 depicting information related to sales of a product for which there is a promotion, according to some embodiments;

FIG. 3 is a block diagram of a system 300 for calculating and presenting information related to the effectiveness of a promotion, according to some embodiments; and

FIG. 4 is a flow chart depicting example operations for calculating and presenting information related to the effectiveness of a promotion, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to calculating and presenting information related to effectiveness of a promotion. In some embodiments, a system for calculating and presenting information related to effectiveness of a promotion comprises a point-of-sale (POS) system, the POS system is configured to collect sales data for products, a display device, the display device configured to present the information related to the effectiveness of the promotion, and a control circuit, wherein the control circuit is communicatively coupled to the POS system and the display device, the control circuit configured to receive, from the POS system, the sales data for products, determine, based on the sales data for products, actual sales for a product over a time period, wherein the actual sales for the product over the time period reflect sales recorded by the POS system for the product during the time period, and wherein the promotion is for the product, calculate, based on the actual sales for the product over the time period, baseline sales for the product over the time period, wherein the baseline sales for the product over the time period represent estimated sales for the product over the time period absent the promotion, calculate, based on sales of an affined product, halo sales of the affined product attributable to the promotion, wherein the halo sales of the affined product attributable to the promotion represent sales of products that are commonly purchased in transactions that include the product, calculate, based on sales of a substitute product, cannibalized sales attributable to the promotion, wherein the cannibalized sales attributable to the promotion represent sales lost of the substitute product replaced by sales of the product, calculate, based on sales of the product after the promotion has ended, one or more of return sales attributable to the promotion and lost sales attributable to the promotion, wherein the return sales attributable to the promotion represent a sale of the product after the promotion has ended, and wherein the lost sales attributable to the promotion represent sales of the product that occur during the promotion in lieu of sales of the product after the promotion, calculate, based on one or more of the actual sales for the product over the time period, the baseline sales for the product over the time period, the halo sales attributable to the promotion, the cannibalized sales attributable to the promotion, the return sales attributable to the promotion, and the lost sales attributable to the promotion, a net lift, wherein the net lift represents the effectiveness of the promotion, and present, via the display device, and indication of the net lift.

As previously discussed, assessing the effectiveness of a promotion can be difficult. While there are simple metrics that can be used (e.g., net sales of product on promotion), these metrics do not provide a complete picture of the impact that the promotion has on sales. As one example, looking only at net sales of the product may not account for lost sales due to customer's purchase of the product in lieu of a substitute product that they would normally purchase. For example, if Brand X shampoo is on sale for $3.00, has a normal price of $6.00, and customers now purchase Brand X shampoo instead of Brand Y shampoo that retails for $10.00, while the sales of Brand X shampoo may have increased, the lost revenue from lowered Brand Y shampoo sales may negate, or even exceed, the increased revenue due to the substitution of Brand X shampoo for Brand Y shampoo as the cost of the Brand X shampoo on promotion is significantly lower than that of the Brand Y shampoo (additionally, the margins for Brand Y shampoo may be considerably higher). As another example, increased sales of a product on promotion may increase sales of a related product that is not on promotion. The increased sales of the related product can be used to evaluate the effectiveness of the promotion, as the increased sales of the related product may be attributable to the promotion.

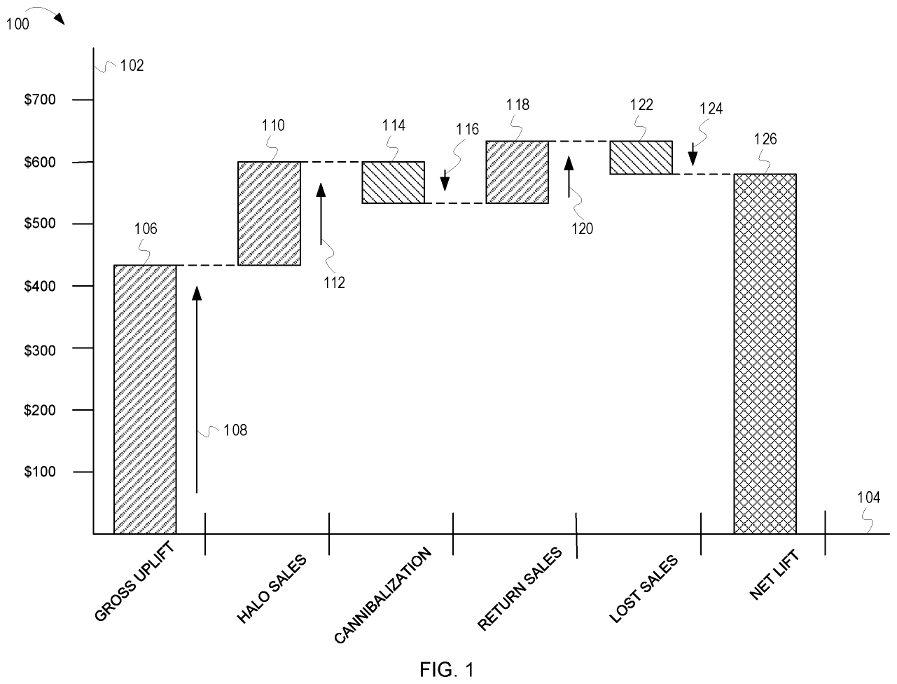

Described herein are systems, methods, and apparatuses for calculating the effectiveness of a promotion and presenting an indication of the effectiveness of the promotion that take into account several components to provide a more robust analysis of the effectiveness of a promotion. The components can include one or more of a gross uplift for a product (based on actual sales of the product and baseline sales of the product), halo sales of an affined product, sales lost due to cannibalization, return trip sales after the promotion ends, and lost sales after the promotion has ended. Based on these components, a net lift is calculated for the promotion. The net lift reflects the additional sales (i.e., lift) observed during a promotion and represents the effectiveness of the promotion. The calculation of the net lift, as well as the components contributing to the net lift, will be discussed in more detail in conjunction with FIG. 1.

FIG. 1 depicts a chart 100 including different components related to sales of a product for which there is a promotion, according to some embodiments. The x-axis 102 of the chart 100 represents sales and the y-axis 104 includes the components. The components include gross uplift 106, halo sales 110, cannibalization 114, return sales 118, and lost sales 122. These components are used to calculate net lift 126. Each component makes up a portion of the net lift 126 and the net lift reflects 126 the additional sales (i.e., lift) observed during a promotion and represents the effectiveness of the promotion. The effectiveness of a promotion can be calculated based on any suitable metric. For example, the net lift can be sales (e.g., a dollar value of sales attributable to the promotion), profit (e.g., a dollar value of sales attributable to a promotion less costs), a quantity (e.g., a number of sales of products attributable to the promotion), etc. For clarity, the example provided herein will refer to the components and the net lift in terms of sales. However, these teaching can be used to calculate the effectiveness of a promotion based on any other suitable metric.

### Gross Uplift

The gross uplift 106 represents the increase in sales of a product on promotion. Put another way, the gross uplift 106 is a reflection of additional sales of the product attributable to the promotion. The gross uplift 106 is calculated based on both actual sales of the product and baseline sales of the product. The actual sales of product are based on sales of the product recorded by a point-of-sale (POS) system, or any other suitable accounting system. In terms of sales as a metric, the actual sales reflect the dollar value of all sales for the product. Typically, the actual sales of the product are determined over a time period, such as the time period in which the promotion is active for the product.

The baseline sales reflect sales for the product absent the promotion. That is, the baseline sales are an estimate of the dollar value of sales for the product had their not been the promotion on the product. Typically, the baseline sales for the product are estimated over a time period, such as the time period in which the promotion is active for the product. The baseline sales for the product can be calculated in any suitable manner and based on any suitable data and/or conditions. For example, the baseline sales can be calculated based on past sales, predicted sales, timing (e.g., season, month, day of the week, etc.), trends, etc. For example, if sales for Product₁ were $X during Month Y of Year Z, $X can be used in the calculation of the baseline sales for the product in Year Z+N. In one embodiment, the baseline sales are calculated based on a function representing the actual sales f(V_{b},Vₚ), where V_{b} represents baseline variables and Vₚ represents promotional variables. The baseline variables are variables that contribute to the baseline sales of the product (e.g., seasonality, trends, weather, macro-economics, geographic location, holidays, etc.). Put simply, the baseline variables that contribute to sales of the product that are not related to a promotion. The promotional variables are variables that contribute to the promotional sales (e.g., promotional flags, channel flags, price, etc.). Put simply, the promotion variables are variables that contribute to the sales of the product that are related to the promotion.

The gross uplift 106 is calculated based on the actual sales and the baselines sales. For example, the gross uplift 106 is the actual sales of the product less the baseline sales of the product. For example, if the actual sales of the product are $1000 and the baseline sales of the product are estimated to be $600, the gross uplift 106 would be $400 (i.e., $400=$1000−$600). With respect to the function described above, the gross uplift 106 would be the sales attributable to the promotional variables.

Typically, the gross uplift 106 is a positive value (i.e., sales for the product increased due to the promotion). Accordingly, as depicted in FIG. 1, the gross uplift 106 is a positive value that increases sales, as depicted by gross uplift arrow 108. If the gross uplift 106 is a positive value, it positively impacts the net lift 126 (i.e., increases the net lift 126). However, in the case that the gross uplift 106 is a negative value (i.e., sales for the product decreased due to the promotion), the gross uplift 106 would negatively impact that net lift 126 (i.e., reduce the net lift 126).

### Halo Sales

The halo sales 110 represents sales of affined products attributable to the promotion. Affined products are products that are commonly purchased with another product (i.e., affined products are commonly purchased with the product on promotion). For example, if the product is ground beef, affined products may include hot dogs, hamburger buns, hot dog buns, cheese, and grilling supplies. Because affined products are typically purchased with the product, when sales of the product increase due to a promotion, sales of the affined products will likely increase (i.e., the affined products will experience a halo increase in sales due to the increase in sales of the product on promotion).

Typically, halo sales 110 is a positive value (i.e., sales for the affined products increase due to the product on promotion). Accordingly, as depicted in FIG. 1, the halo sales 110 is a positive value that increases sales, as depicted by halo sales arrow 112. If the halo sales 110 is a positive value, it positively impacts the net lift 126 (i.e., increases the net lift 126). However, in the case that the halo sales 110 is a negative value (i.e., sales of the affined products decreased due to the promotion on the product), the halo sales 110 would negatively impact the net lift 126 (i.e., reduce the net lift 126).

In some embodiments, the calculation of the halo sales 110 is only performed for products that are determined to be affined with the product on promotion. In such embodiments, whether a product is affined can be based on historical sales. In some embodiments, whether a product is affined with the product on promotion is determined based on an affinity index and a threshold. If the affinity index is above the threshold, the product is considered to be affined with the product on promotion. In one embodiment, the affinity index is a ratio of sales of the product (i.e., the product on promotion) that include the affined product divided by the sales of the product and sales of the affined product not including the product and total purchases recorded by the POS system. In such embodiments, the affinity index can be written as an equation:

$$Affinity Index = \frac{A ⋂ B / A}{B / U} ,$$

where A=the number of transactions including the product on promotion, B=the number of transactions including the affined product, A∩B=the number of transactions that include both the product on promotion and the affined product (i.e., the intersection of A and B), and U=the total number of transactions. For example, assume that there are a total of 160 transactions (i.e., U=160), the product on promotion is included in 30 of the transactions (i.e., A=30), the affined product is included in 20 of the transactions, and that the purchases occur in such a manner that 15 of the transaction that included the product on promotion and the affined product (A∩B=15). In this example, the calculation of the affinity index would be—

$$Affinity Index = \frac{A ⋂ B / A}{B / U} = \frac{15 / 30}{20 / 160} = \frac{0.5}{0.125} = 4.$$

With respect to the aforementioned equation, the numerator is a ratio of the number of transactions that include the product on promotion and the affined product to the number of transaction including the product on promotion, and the denominator is a ratio of the number of transactions including the affined product to the total number of transactions. In this way, the equation provides a metric representing how frequently the product and the affined product are purchased together. With regard to the threshold, a value can be chosen to indicate whether a product is affined with the product on promotion. As one example, an affinity index over 1.2 may indicate that the product is affined with the product on promotion. Additionally, an affinity index of 1.2 may indicate that there is no relationship between purchases of the product and the product on promotion, and an affinity index below 1.2 may indicate that there is a negative correlation between purchases of the product and the product on promotion (discussed in more detail with respect to cannibalized sales). In the example noted above, in which there are a total of 160 transactions (i.e., U=160), the product on promotion is included in 30 of the transactions (i.e., A=30), the affined product is included in 20 of the transactions, and that the purchases occur in such a manner that 15 of the transaction that included the product on promotion and the affined product (A∩B=15), affinity index is 4. Because 4 is greater than 1.2 (i.e., the affinity index is above the threshold, the product and the affined product would be affined, and sales of the affined product would be included in the calculation of the halo sales 110.

Oftentimes, promotions are running for multiple products simultaneously. For example, a promotion for shampoo and a promotion for body wash may overlap (i.e., at least a portion of the promotion for the shampoo occurs during a time period in which at least a portion of the promotion for body wash occurs). Because shampoo and body wash are similar products (e.g., products in a common category), both the shampoo and the body wash may be affined with a common item, such as conditioner. That is, the promotion for the shampoo may cause an increase in conditioner sales and the promotion for the body wash may cause an increase in conditioner sales. In some embodiments, the system can account for this multiple promotion scenario by estimating the contribution each product on promotion makes to the increased non-promotional product (i.e., the conditioner in this example). In one embodiments, attributes the halo sales 110 of the product based on the affinity index with the products on promotion. For example, the halo sales 110 can be attributed based on the following equation:

$$Sales Attributable to {Item}_{1} = Lift * \frac{Afinity Index of {Item}_{1}}{Affinity Index of {Item}_{1} + Affinity Index of {Item}_{2}} .$$

Continuing the example above, if the affinity index of conditioner with the shampoo is 4, the affinity index of the conditioner with the body wash is 4, and the halo sales 110 of the conditioner is $9, sales of the conditioner attributable to the shampoo would be $6 (i.e., Sales Attributable to Shampoo=9*4/6) and the sales of the conditioner attributable to the body wash would be $3 (i.e., Sales Attributable to Shampoo=9*2/6). If more than two items are on promotion, the denominator of the above-noted equation can be the sum of all affinity indexes.

In embodiments in which the calculation of halo sales 110 is only performed for products above the threshold, computational overhead can be decreased. While a value of 1.2 is used as an example threshold, any suitable value can be used. Additionally, the threshold value may depend on types of products, categories, or products, costs of products, etc.

### Cannibalization

The cannibalization 114 represents a decrease in sales of other (e.g., substitute) products attributable to the promotion. For example, a customer may purchase the product on promotion in lieu of the other product. As one example, if the product on promotion is Diet Coke and the other product is Diet Pepsi, a customer that typically purchases Diet Pepsi may choose to purchase Diet Coke because there is a promotion for Diet Coke. That is, the customer may substitute Diet Coke for Diet Pepsi (i.e., the customer replaced Diet Pepsi with Diet Coke). The sale of Diet Pepsi lost due to the sale of Diet Coke in this case would represent a cannibalization of a Diet Pepsi sale by a Diet Coke sale.

Typically, cannibalization 114 is a negative value (i.e., sales of another product have decreased due to replacement sales of the product on promotion). Accordingly, as depicted in FIG. 1, cannibalization 114 is a negative value that decreases sales, as depicted by cannibalization arrow 116. If the cannibalization 114 is a negative value, it negatively impacts the net lift 126 (i.e., reduce net lift 126). However, in the case that the cannibalization 114 is a positive value (i.e., sales of the other product increased due to the promotion on the product), the cannibalization 114 would positively impact the net lift 126 (i.e., increase the net lift 126).

Like the halo sales 110, in some embodiments, the cannibalization 114 can be calculated only for products that are considered competitive and/or substitute products. Accordingly, an affinity index can be calculated for the other products. If the affinity index is below the threshold, then the cannibalization 114 is calculated for the product. Continuing the example above, if the affinity index for a substitute product is less than 1.2, it may be indicative of the fact that customers are unlikely to purchase both the product on promotion and the substitute product. Accordingly, it is possible that increased sales of the product on promotion may come at a decrease in sales of the substitute product.

As an example, again assume there are a total of 160 transactions (i.e., U=160), the product on promotion is included in 30 of the transactions (i.e., A=30), the substitute product is included in 20 of the transactions, and that the purchases occur in such a manner that 1 of the transaction that included the product on promotion and the affined product (A∩B=1). In this example, the calculation of the affinity index would be—

$$Affinity Index = \frac{A ⋂ B / A}{B / U} = \frac{1 / 30}{20 / 160} = \frac{0.33}{0.125} = 0.267 .$$

Because 0.267 is less than 1.2 (i.e., the affinity index is below the threshold, the product and the substitute product would be negatively affined, and sales of the substitute product would be included in the calculation of the cannibalization 114.

Much like halo sales can be attributable to multiple products on promotion, the cannibalization 114 may be attributable to multiple products on promotion. In some embodiments, the system attributes cannibalization to multiple products on promotion based on a ratio of sales of the substitute product to the sales of the category to which the substitute product belongs multiplied by the sales of the product on promotion. This can be expressed with the following equation:

$$Cannibalization Due to A = \frac{Sales of Item A}{Total Sales in Category} *$$

Sales Lost of Substitute Item. For example, if Product_{A} and Product_{B} are on promotion, $500 worth of Product_{A} are sold, $1200 worth of Product_{B} are sold, total sales in the category is $5000, and the lost sales of the substitute product is $50, the cannibalization 114 due to Product_{A} is

$$\$5 ( \frac{500}{5000} * 50 = 5 )$$

and the cannibalization due to Product_{B} is

$$\$12 ( \frac{1200}{5000} * 50 = 12 ) .$$

### Return Sales

The return sales 118 represents sales of the product on promotion that occur after the promotion has ended. These sales are return sales 118 when the sales are attributable to the promotion. For example, as discussed above, when Diet Coke is on promotion, the customer may substitute his or her typical Diet Pepsi purchase with a Diet Coke purchase. If, after the promotion ends, the customer continues purchasing Diet Coke instead of Diet Pepsi, these continued Diet Coke sales would be return sales. In some embodiments, the return sales 118 is calculated based on baseline sales for the product. That is, sales above and beyond what is expected for the product are the return sales 118. In some embodiments, the return sales 118 is only calculated for a time period after the promotion has ended (e.g., a number of days, weeks, months, etc.).

Typically, the return sales 118 is a positive value (i.e., sales of the product continue at an increased level after the promotion due to the promotion). Accordingly, as depicted in FIG. 1, the return sales 118 is a positive value that increases sales, as depicted by return sales arrow 120. If the return sales 118 is a positive value, it positively impacts the net lift 126 (i.e., increases the net lift 126). However, in the case that the return sales 118 is a negative value (i.e., sales of the product proceed at a decreased level after the promotion due to the promotion), the return sales 118 would negatively impact the net lift 126 (i.e., reduce the net lift 126).

### Lost Sales

The lost sales 122 represents decreased sales of the product after the promotion has ended. For example, a customer may buy additional ones of the product during the promotion (e.g., “stock up” on the product) due to the promotional price. In this case, the customer may not purchase more of the product for some time. Put another way, the customer made a purchase of the product during the promotion to decrease the amount of the product that the customer must buy after promotion has ended. In some embodiments, the lost sales 122 is only calculated for certain products or categories of products. For example, perishable items may not realize significant lost sales because it is difficult, if not impossible, for a customer to “stock up” on perishable items. The customer's purchase of additional ones of the product during the promotion result in lost sales of the product after the promotion has ended. In some embodiments, the return sales 118 is only calculated for a time period after the promotion has ended (e.g., a number of days, weeks, months, etc.).

Typically, the lost sales 122 is a negative value (i.e., lost sales after the promotion has ended). Accordingly, as depicted in FIG. 1, the lost sales 122 is a negative value that decreases sales, as depicted by lost sales arrow 124. If the lost sales 122 is a negative value, it negatively impacts net lift 126 (i.e., reduce net lift 126). However, in the case that the lost sales 122 is a positive value (i.e., sales of the product increase after the promotion), the lost sales 122 would positively impact the net lift 126 (i.e., increase the net lift 126).

### Net Lift

Finally, as previously discussed, the net lift 126 reflects the additional sales (i.e., lift) observed during a promotion and represents the effectiveness of the promotion. In the example chart 100 depicted in FIG. 1, the gross uplift 106, the halo sales 110, the cannibalization 114, the return sales 118, and the lost sales 122 all contribute to the net lift 126. In this example, the net lift 126 is equal to the gross uplift 106 plus the halo sales 110 minus the cannibalization 114 plus the return sales 118 minus the lost sales 122. That is, the gross uplift 106, the halo sales 110, and the return sales 118 positively impact the net lift 126, while the cannibalization 114 and the lost sales 122 negatively impact the net lift 126. The net lift 126 is the sum of these components.

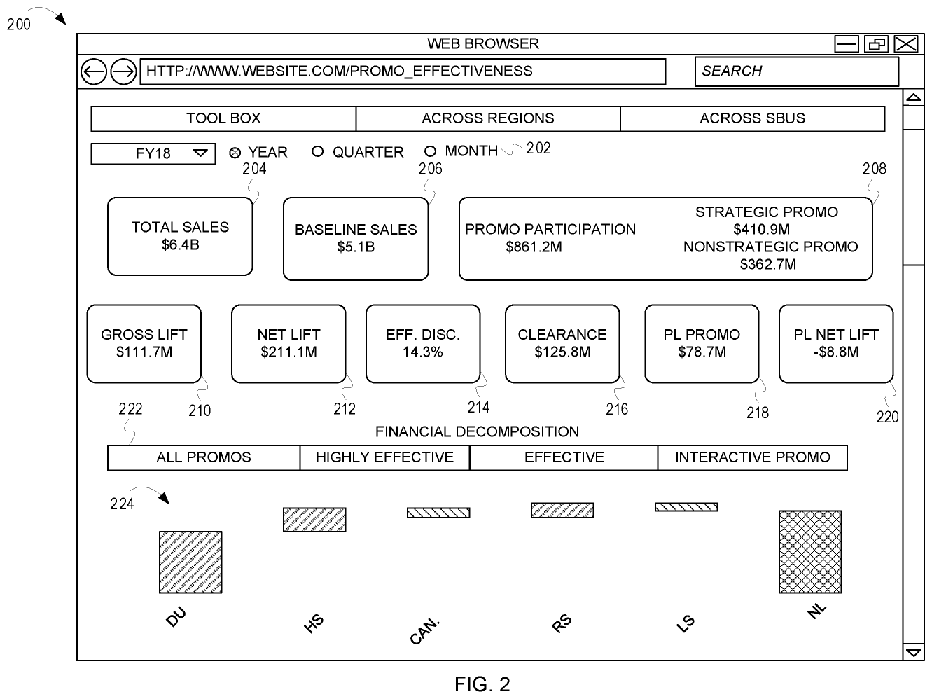

While the discussion of FIG. 1 provides an overview of components that can be used to calculate the net lift, the discussion of FIG. 2 provides a discussion of an example user interface that can be used to present information related to the effectiveness of a promotion.

FIG. 2 is an example user interface presented via a browser 200 depicting information related to sales of a product for which there is a promotion, according to some embodiments. Although FIG. 2 depicts the user interface being presented via a browser 200, such a presentation mechanism is not required. Instead, the user interface can be presented via a thick client application. As depicted in the example in FIG. 2, the user interface can be a graphical user interface (GUI). The user interface includes information (i.e., data) related to sales of a product for which there is a promotion and information (i.e., data) reflecting the effectiveness of the promotion. For example, the user interface includes a total sales indicator 204, a baseline sales indicator 206, a promotional participation indicator 208, a gross lift indicator 210, a net lift indicator 212, an effective discount indicator 214, a clearance indicator 216, a PL net lift indicator 220, and a graphic 224 representing components related to the effectiveness of the promotion.

Additionally, the user interface includes user selectable options. The user interface depicted in FIG. 2 provides a few example selectable options. The selectable options allow the user to modify the presentation of data. The selectable options included in the user interface depicted in FIG. 2 include a timing selector 202 and a financial decomposition selector 222. The timing selector 202 allows a user to select a time period for which to view the data. For example, the user can select a year, quarter, or month to view. The financial decomposition selector 222 allows the user to select between different values, such as “all promos,” “highly effective,” “effective,” and “interactive promo.”

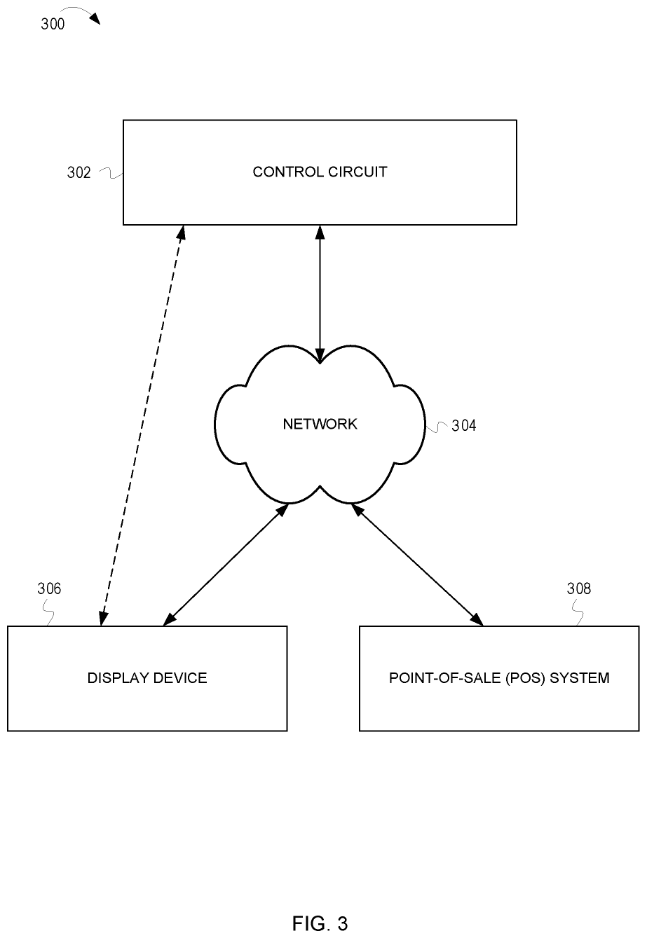

While the discussion of FIG. 2 provides description of an example user interface for presenting information related to a promotion, the discussion of FIG. 3 describes an example system for calculating and presenting information related to the effectiveness of a promotion.

FIG. 3 is a block diagram of a system 300 for calculating and presenting information related to the effectiveness of a promotion, according to some embodiments. The system 300 includes a control circuit 302, a network 304, a display device 306, and a point-of-sale (POS) system.

The control circuit 302 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 302 is configured (for example, by using corresponding programming as will be well understood by those skilled in the art) to carry out one or more of the steps, actions, and/or functions described herein.

By one optional approach the control circuit 302 operably couples to a memory. The memory may be integral to the control circuit 302 or can be physically discrete (in whole or in part) from the control circuit 302 as desired. This memory can also be local with respect to the control circuit 302 (where, for example, both share a common circuit board, chassis, power supply, and/or housing) or can be partially or wholly remote with respect to the control circuit 302 (where, for example, the memory is physically located in another facility, metropolitan area, or even country as compared to the control circuit 302).

This memory can serve, for example, to non-transitorily store the computer instructions that, when executed by the control circuit 302, cause the control circuit 302 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 302 is configured to perform determinations and calculations related to the components of the net lift, as well as the net lift, as described above. The control circuit 302 can perform these determinations and calculations based on data received from the POS system 308.

The POS system 308 collects sales data for products that are sold within the retail facility. The POS system 308 can be specific to the retail facility (i.e., the POS system 308 collects sales data for sales only in or associated with the retail facility) or associated with a number of retail facilities. The POS system 308 includes all subsystems necessary to collect sales data for the products. For example, the POS system 308 can include POS terminals, databases, transaction processing devices, etc. The POS system 308 transmits the sales data for the products to the control circuit 302 via the network 304. The network 304 can be any suitable type of network (e.g., the Internet, an intranet, etc.).

The display device 306 is configured to present the information related to the effectiveness of a promotion. For example, the display device 306 can present the information depicted in FIG. 1 and/or FIG. 2, as well as any other desired information. The display device 306 can be of any suitable type. For example, the display device 306 can be an liquid crystal display (LCD) device, cathode ray tube (CRT) device, light emitting diode (LED) device, etc. Additionally, in some embodiments, the display device 306 can be associated with the control circuit 302. For example, the control circuit 302 and the display device 306 can be housed in a single computing device. Alternatively, the display device 306 can be remote from the control circuit 302 (i.e., the display device 306 can be a device physically separate from the control circuit 302). In such embodiments, the control circuit 302 and the display device 306 can communicate with one another via the network 304.

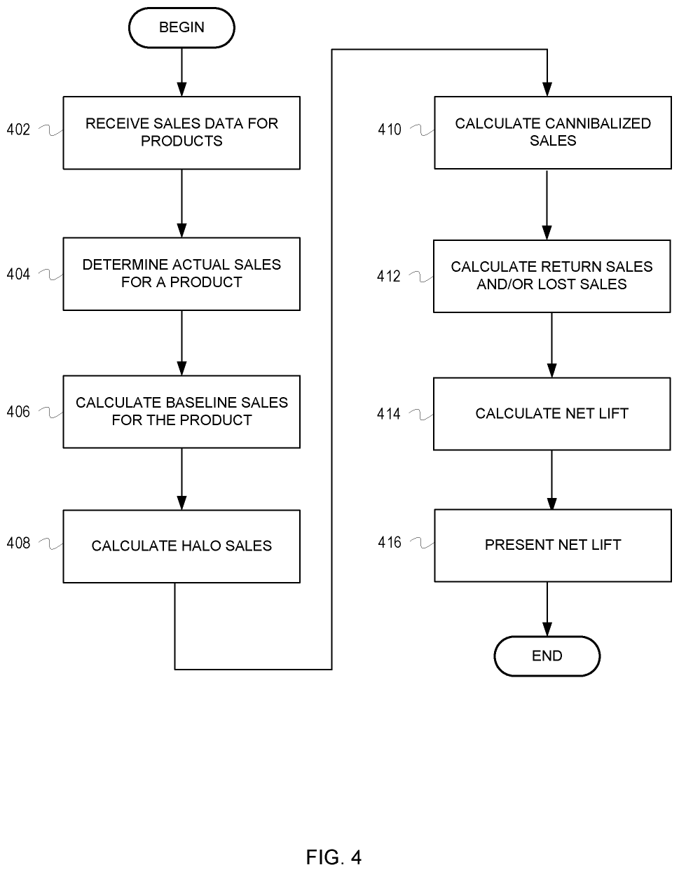

While the discussion of FIG. 3 provides detail regarding a system for calculating and presenting information related to the effectiveness of a promotion, the discussion of FIG. 4 provides example operations for calculating and presenting information related to the effectiveness of a promotion.

FIG. 4 is a flow chart depicting example operations for calculating and presenting information related to the effectiveness of a promotion, according to some embodiments. The flow begins at block 402.

At block 402, sales data for products is received. For example, a control circuit can receive the sales data for products from a POS system. The sales data for products can include sales quantities for products, total value received for the sale of products, indications of products purchased in a single transaction, timing information related to transactions, etc. The flow continues at block 404.

At block 404, actual sales for a product are determined. For example, the control circuit can determine actual sales for the product. The control circuit can determine the actual sales for the product based on the sales data for product received from the POS system. The actual sales for the product reflect sales recorded by the POS system during a time period. In some embodiments, the product is a product for which a promotion is running. The flow continues at block 406.

At block 406, baselines sales are calculated for a product. For example, the control circuit can calculate the baseline sales for the product. The control circuit can calculate the baseline sales for the product based on the actual sales for the product. Additionally, the calculation of the baseline sales for the product can take into account other factors, such as baseline variables and promotion variables. The baseline sales for the product represent estimated sales for the product absent the promotion. That is, the baseline sales for the product is an estimate of sales of the product if the product was not on promotion. In some embodiments, the baseline sales are calculated for a time period, such as a time period in which the promotion is running. The flow continues at block 408.

At block 408, halo sales are calculated. For example, the control circuit can calculate the halo sales. The halo sales represent sales of products that are commonly purchased in transactions that include the product. In some cases, the halo sales represent sales of products affined with the product. The halo sales are attributable to the promotion. For example, increased sales of the product due to the promotion may cause an increase in sales of the affined product. The halo sales represent the increased sales of the affined product. In some embodiments, halo sales are only calculated for certain products. For example, halo sales may only be calculated for products that are determined to be affined with the product. The determination that a product is affined with the product can be based on a calculation, such as that of an affinity index. The flow continues at block 410.

At block 410, cannibalized sales are calculated. For example, the control circuit can calculate the cannibalized sales. The cannibalized sales represent sales lost of a substitute product attributable to the promotion. For example, because a promotion is running for the product, customers may purchase the product in lieu of the substitute product, resulting in diminished sales of the substitute product. In some embodiments, cannibalized sales are only calculated for products that are negatively affined with the product (i.e., the other products are substitutes for the product). This negative affinity can be determined based on a calculation, such as the calculation of an affinity index. The flow continues at block 412.

At block 412, return sales and/or lost sales are calculated. For example, the control circuit can calculate the return sales and/or the lost sales. The return sales represent sales of the product after the promotion has ended. For example, a customer may purchase the product during the promotion and decide that he or she likes the product. If the customer then returns and continues purchasing the product, these continued purchases are return sales. Because the customer initially purchased the product due to the promotion, the return sales are attributable to the promotion. The lost sales represent sales of the product that occur during the promotion in lieu of sales of the product that occur after the promotion. For example, a customer may purchase excess of a product during the promotion due to the promotion. Because the customer purchased excess of the product during the promotion, he or she may not purchase as much, if any, of the product in a time period following the initial purchase during the promotion. Because the initial purchase was due to the promotion, the lost sales that follow are attributable to the promotion. The flow continues at block 414.

At block 414, net lift is calculated. For example, the control circuit can calculate the net lift. The net lift represents the effectiveness of the promotion. In some embodiments, the control circuit calculates the net lift based on one or more of the actual sales, baseline sales, halo sale, cannibalized sales, return sales, and lost sales. In such embodiments, each of these components may have a positive, negative, or neutral impact on the net lift. That is, each of the components may increase the net lift, decrease the net lift, or have no impact on the net lift. The flow continues at block 416.

At block 416, an indication of the net lift is presented. For example, the control circuit can present (i.e., cause presentation) of the indication of the net lift on a display device. In some embodiments, the display device presents the net lift via a user interface.

### Promotion Tagging and Grouping

In some embodiments, promotions are tagged by identifying a unique combination of features of the promotion. For example, the features can include the product, store, pricing mechanics, support channels, promotion start dates, promotion end dates, etc. The tags are representative of the unique combinations of the features of the promotion. For example, a promotion ID can include a component for item number (A), a store number (1000), a pricing mechanic (rollback), a support channel (CPP) and a promo start week (11652). The promotion ID for this example promotion would be A1000RC11652 (i.e., a combination of each of the features of the promotion). In some embodiments, the promotion ID spans across the different weeks of the promotion. This can aid in identifying week-over-week changes. Additionally, such tagging can help separate promotions that running simultaneously. In addition to tagging, in some embodiments, the promotions can be grouped. For example, the promotion groups can be defined in a dynamic manner to group the promotions on different products together based on certain characteristic parameters. For example, promotions can be grouped by mechanics, support, department, category, subcategory, vendor, start date, duration, etc. In some embodiments, promotion tagging aids in grouping products in the same categories/subcategories/etc. based on characteristic parameters. This can aid in understanding promotion responses as a group by, for example, aggregating net lift over promotional groups rather than individual products.

In some embodiments, a system for calculating and presenting information related to effectiveness of a promotion comprises a point-of-sale (POS) system, the POS system is configured to collect sales data for products, a display device, the display device configured to present the information related to the effectiveness of the promotion, and a control circuit, wherein the control circuit is communicatively coupled to the POS system and the display device, the control circuit configured to receive, from the POS system, the sales data for products, determine, based on the sales data for products, actual sales for a product over a time period, wherein the actual sales for the product over the time period reflect sales recorded by the POS system for the product during the time period, and wherein the promotion is for the product, calculate, based on the actual sales for the product over the time period, baseline sales for the product over the time period, wherein the baseline sales for the product over the time period represent estimated sales for the product over the time period absent the promotion, calculate, based on sales of an affined product, halo sales of the affined product attributable to the promotion, wherein the halo sales of the affined product attributable to the promotion represent sales of products that are commonly purchased in transactions that include the product, calculate, based on sales of a substitute product, cannibalized sales attributable to the promotion, wherein the cannibalized sales attributable to the promotion represent sales lost of the substitute product replaced by sales of the product, calculate, based on sales of the product after the promotion has ended, one or more of return sales attributable to the promotion and lost sales attributable to the promotion, wherein the return sales attributable to the promotion represent a sale of the product after the promotion has ended, and wherein the lost sales attributable to the promotion represent sales of the product that occur during the promotion in lieu of sales of the product after the promotion, calculate, based on one or more of the actual sales for the product over the time period, the baseline sales for the product over the time period, the halo sales attributable to the promotion, the cannibalized sales attributable to the promotion, the return sales attributable to the promotion, and the lost sales attributable to the promotion, a net lift, wherein the net lift represents the effectiveness of the promotion, and present, via the display device, and indication of the net lift.

In some embodiments, an apparatus and a corresponding method performed by the apparatus comprises receiving, at a control circuit from a point-of-sale (POS) system, sales data for products, determining, by the control circuit based on the sales data for the products, actual sales for a product over a time period, wherein the actual sales for the product over the time period represent sales recorded by the POS system for the product during the time period, and wherein the promotion is for the product, calculating, based on the actual sales for the product over the time period, baseline sales for the product over the time period, wherein the baseline sales for the product over the time period represent estimated sales for the product over the time period absent the promotion, calculating, based on sales of an affined product, halo sales of the affined product attributable to the promotion, wherein the halo sales of the affined product attributable to the promotion represent sales of products that are commonly purchased in transactions that include the product, calculating, based on sales of a substitute product, cannibalized sales attributable to the promotion, wherein the cannibalized sales attributable to the promotion represent sales lost of the substitute product replaced by sales of the product, calculating, based on sales of the product after promotion has ended, one or more of return sales attributable to the promotion and lost sales attributable to the promotion, wherein the return sales attributable to the promotion represent a sale of the product after the promotion has ended, and wherein the lost sales attributable to the promotion represent sales of the product that occur during the promotion in lieu of sales of the product after the promotion, calculating, based on one or more of the actual sales for the product over the time period, the baseline sales for the product over the time period, the halo sales attributable to the promotion, the cannibalized sales attributable to the promotion, the return sales attributable to the promotion, and the lost sales attributable to the promotion, a net lift, wherein the net lift represents the effectiveness of the promotion, an presenting, via the display device, an indication or the net lift.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for calculating and presenting information related to effectiveness of a promotion, the system comprising:
a point-of-sale (POS) system, the POS system is configured to collect sales data for products;
a display device, the display device configured to present the information related to the effectiveness of the promotion; and
a control circuit, wherein the control circuit is communicatively coupled to the POS system and the display device, the control circuit configured to:
receive, from the POS system, the sales data for products;
determine, based on the sales data for products, actual sales for a product over a time period, wherein the actual sales for the product over the time period reflect sales recorded by the POS system for the product during the time period, and wherein the promotion is for the product;
calculate, based on the actual sales for the product over the time period, baseline sales for the product over the time period, wherein the baseline sales for the product over the time period represent estimated sales for the product over the time period absent the promotion;
calculate, based on sales of an affined product, halo sales of the affined product attributable to the promotion, wherein the halo sales of the affined product attributable to the promotion represent sales of products that are commonly purchased in transactions that include the product;
calculate, based on sales of a substitute product, cannibalized sales attributable to the promotion, wherein the cannibalized sales attributable to the promotion represent sales lost of the substitute product replaced by sales of the product;
calculate, based on sales of the product after the promotion has ended, one or more of return sales attributable to the promotion and lost sales attributable to the promotion, wherein the return sales attributable to the promotion represent a sale of the product after the promotion has ended, and wherein the lost sales attributable to the promotion represent sales of the product that occur during the promotion in lieu of sales of the product after promotion;
calculate, based on one or more of the actual sales for the product over the time period, the baseline sales for the product over the time period, the halo sales attributable to the promotion, the cannibalized sales attributable to the promotion, the return sales attributable to the promotion, and the lost sales attributable to the promotion, a net lift, wherein the net lift represents the effectiveness of the promotion; and
present, via the display device, an indication of the net lift.

2. The system of claim 1, wherein the control circuit is further configured to:
calculate, for at least one other product, an affinity index, wherein the affinity index is representative of an affinity for the at least one other product and the product.

3. The system of claim 2, wherein the affinity index is a ratio of sales of the product that include the affined product divided by sales of the product and sales of the affined product not including the product and total purchases recorded by the POS system.

4. The system of claim 3, wherein the affinity index over a threshold indicates that the product and the affined product are affined.

5. The system of claim 4, wherein the calculation of halo sales is only performed for products where the affinity index above the threshold.

6. The system of claim 2, wherein the affinity index is a ratio of sales of the product that include the substitute product divided by sales of the product and sales of the substitute product not including the product and total purchases recorded by the POS system.

7. The system of claim 6, wherein the affinity index below a threshold indicates that the product and the substitute product are negatively affined.

8. The system of claim 7, wherein the calculation of cannibalized sales is only performed for products where the affinity index below the threshold.

9. The system of claim 1, wherein the baseline sales are a function of baseline variables and promotion variables, and wherein the baseline sales are calculated based on the baseline variables.

10. The system of claim 1, wherein the net lift is equal to the actual sales for the product over the time period minus baseline sales for the product over the time period plus halo sales of the affined product attributable to the product minus cannibalized sales attributable to the product plus return sales attributable to the promotion minus lost sales attributable to the promotion.

11. A method for calculating and presenting information related to the effectiveness of a promotion, the method comprising:
receiving, at a control circuit from a point-of-sale (POS) system, sales data for products;
determining, by the control circuit based on the sales data for products, actual sales for a product over a time period, wherein the actual sales for the product over the time period represent sales recorded by the POS system for the product during the time period, and wherein the promotion is for the product;
calculating, based on the actual sales for the product over the time period, baseline sales for the product over the time period, wherein the baseline sales for the product over the time period represent estimated sales for the product over the time period absent the promotion;
calculating, based on sales of an affined product, halo sales of the affined product attributable to the promotion, wherein the halo sales of the affined product attributable to the promotion represent sales of products that are commonly purchased in transactions that include the product;
calculating, based on sales of a substitute product, cannibalized sales attributable to the promotion, wherein the cannibalized sales attributable to the promotion represent sales lost of the substitute product replaced by sales of the product, wherein the return sales attributable to the promotion represent a sale of the product after the promotion has ended, and wherein the lost sales attributable to the promotion represent sales of the product that occur during the promotion in lieu of sales of the product after promotion;
calculating, based on sales of the product after the promotion has ended, one or more of return sales attributable to the promotion and lost sales attributable to the promotion;
calculating, based on one or more of the actual sales for the product over the time period, the baseline sales for the product over the time period, the halo sales attributable to the promotion, the cannibalized sales attributable to the promotion, the return sales attributable to the promotion, and lost sales attributable to the promotion, a net lift; and
presenting, via a display device, an indication of the net lift.

12. The method of claim 11, further comprising:
calculating, for at least one other product, an affinity index, wherein the affinity index is representative of an affinity for the at least one other product and the product.

13. The method of claim 12, wherein the affinity index is a ratio of sales of the product that include the affined product divided by sales of the product and sales of the affined product not including the product and total purchases recorded by the POS system.

14. The method of claim 13, wherein the affinity index over a threshold indicates that the product and the affined product are affined.

15. The method of claim 14, wherein the calculation of halo sales is only performed for products where the affinity index above the threshold.

16. The method of claim 12, wherein the affinity index is a ratio of sales of the product that include the substitute product divided by sales of the product and sales of the substitute product not including the product and total purchases recorded by the POS system.

17. The method of claim 16, wherein the affinity index below a threshold indicates that the product and the substitute product are negatively affined.

18. The method of claim 17, wherein the calculation of cannibalized sales is only performed for products where the affinity index is below the threshold.

19. The method of claim 11, wherein the display device presents the net lift via a graphical user interface (GUI).

20. The method of claim 11, wherein the net lift is equal to the actual sales for the product over the time period minus baseline sales for the product over the time period plus halo sales of the affined product attributable to the promotion minus cannibalized sales attributable to the product plus return sales attributable to the promotion minus lost sales attributable to the promotion.
